(19) United States
(12) Patent Application Publication
(10) Pub. No.: US 2025/0378580 A1
(43) Pub. Date: Dec. 11, 2025

(54) GAZE ONLINE LEARNING

(71) Applicant: Apple Inc., Cupertino, CA (US)

(72) Inventors: Yikang Liao, Sunnyvale, CA (US); Joerg A Lieblet, Los Gatos, CA (US); Zeyad A Emam, San Mateo, CA (US); Hao Qin, Saratoga, CA (US); Kelsey Y Ho, Los Altos, CA (US); Ankit Gupta, Santa Clara, CA (US)

(21) Appl. No.: 19/206,680

(22) Filed: May 13, 2025

Related U.S. Application Data
(60) Provisional application No. 63/657,464, filed on Jun. 7, 2024.

(51) Int. Cl. G06T 7/73; G06F 3/01

(52) U.S. Cl. CPC G06T 7/75; G06F 3/013; G06T 2207/20081; G06T 2207/30201

(57) ABSTRACT

Various implementations disclosed herein include devices, systems, and methods that predict a gaze position. For example, a process may obtain an enrolled eye model of a user that was determined based on sensor data obtained via one or more sensors of an electronic device. The process may further obtain eye-model inaccuracy information corresponding to inaccuracies of prior gaze position predictions determined using the enrolled eye 3D model and generate a predicted gaze position based on the enrolled eye model. The predicted gaze position may correspond to a position on display of the electronic device. The process may further generate a corrected gaze position based on output of a correction process that receives as input the predicted gaze position and the eye-model inaccuracy information.

### CROSS-REFERENCE TO RELATED APPLICATIONS

This Application claims the benefit of U.S. Provisional Application Ser. No. 63/657,464 filed Jun. 7, 2024, which is incorporated herein in its entirety.

### TECHNICAL FIELD

The present disclosure generally relates to systems, methods, and devices that predict and correct gaze position with respect to an enrolled eye model.

### BACKGROUND

Existing techniques for estimating and correcting eye-based attributes with respect to viewing content on a display of a device may be improved with respect to simplicity and accuracy to provide desirable viewing experiences.

### SUMMARY

Various implementations disclosed herein include devices, systems, and methods that predict gaze position by initiating enrolled eye model (e.g., a three-dimensional (3D) eye-model) based predictions and correcting the predicted gaze position using a correction process accounting for a historical inaccuracy of the enrolled eye model predictions. The enrolled eye model predictions may be based on a 3D eye model that may include information associated with a 3D geometry of an eye of a user such as, inter alia, a cornea shape, a pupil radius, eye dimensions, etc. The gaze position may be associated with an x/y position on a display (e.g., of a head mounted device (HMD)) at which a gaze is directed. The correction process may be model or transformer based and use inaccuracy information, such as errors or residuals (e.g., a difference between an actual value and a predicted value), that is based on prior use of the 3D eye-model to make gaze predictions with respect to ground truth gaze information. For example, using a center location of a virtual button as a ground truth for a gaze location when a user performs a pinch gesture to select the virtual button.

In some implementations, inaccuracy information may be based on one or more prior user sessions and/or events occurring online or live (in real time) during a current user session. In some implementations, the inaccuracy information may include a set (e.g., a matrix/tokens) of historical and/or current user data that may be input into a correction process. In some implementations, prior user sessions may include, inter alia, an enrollment session occurring during an initial device set up process.

In some implementations, an enrolled eye model may be determined based on sensor data obtained during a single enrollment session. In this example, the 3D eye-model may be generated using obtained sensor data during the enrollment session.

In some implementations, historical model inaccuracy information may be determined based on sensor data gathered subsequent to the single enrollment session, during regular user sessions, and prior to obtaining current gaze tracking data.

In some implementations, recorded sensor data may be replayed to provide input to the enrolled eye model to make gaze position predictions that are compared to ground truth gaze positions. For example, assumed gaze positions at input events such as virtual button “clicks” for activation.

In some implementations, an electronic device has a processor (e.g., one or more processors) that executes instructions stored in a non-transitory computer-readable medium to perform a method. The method performs one or more steps or processes. In some implementations, the electronic device obtains an enrolled eye model of an eye of a user that was determined based on sensor data obtained via one or more sensors of the electronic device. In some implementations, eye-model inaccuracy information corresponding to inaccuracies of prior gaze position predictions determined using the enrolled eye model may be obtained. In some implementations, a predicted gaze position may be generated based on the enrolled model of the eye. The predicted gaze position may correspond to a position on one or more displays of the electronic device. In some implementations, a corrected gaze position may be generated based on an output of a correction process that receives as input the predicted gaze position and the eye-model inaccuracy information.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRA WINGS

So that the present disclosure can be understood by those of ordinary skill in the art, a more detailed description may be had by reference to aspects of some illustrative implementations, some of which are shown in the accompanying drawings.

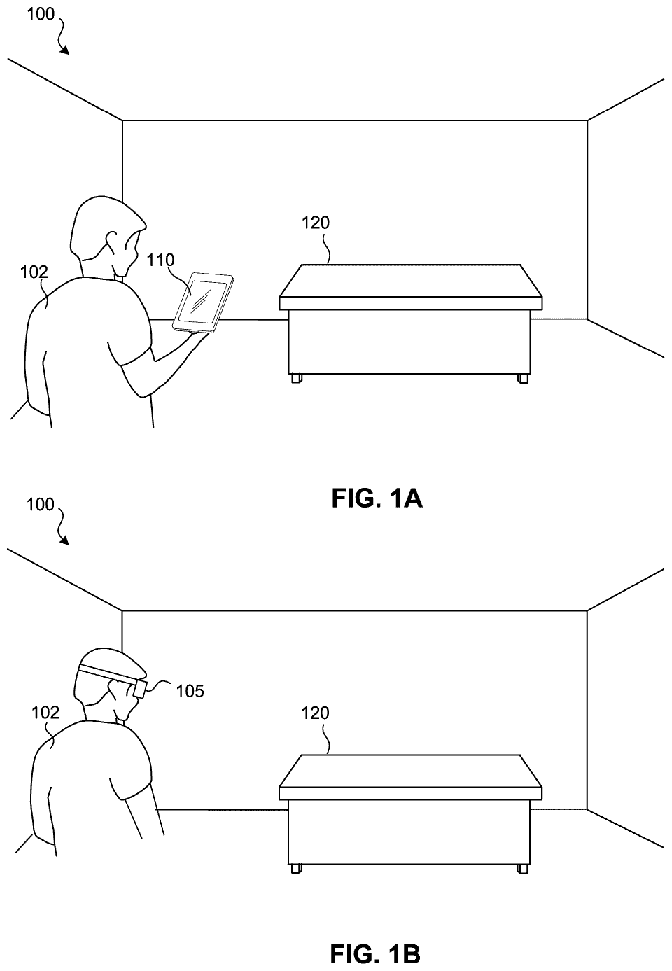

FIGS. 1A-B illustrate exemplary electronic devices operating in a physical environment in accordance with some implementations.

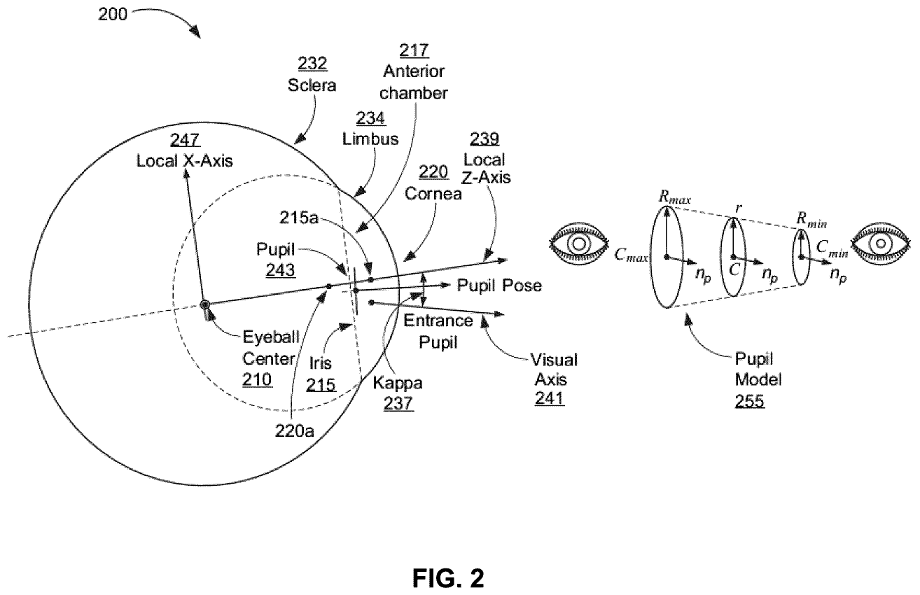

FIG. 2 illustrates is a diagram depicting a 3D eye model comprising a 3D representation of an eyeball to illustrate example eye modeling implementations for gaze tracking, in accordance with some implementations.

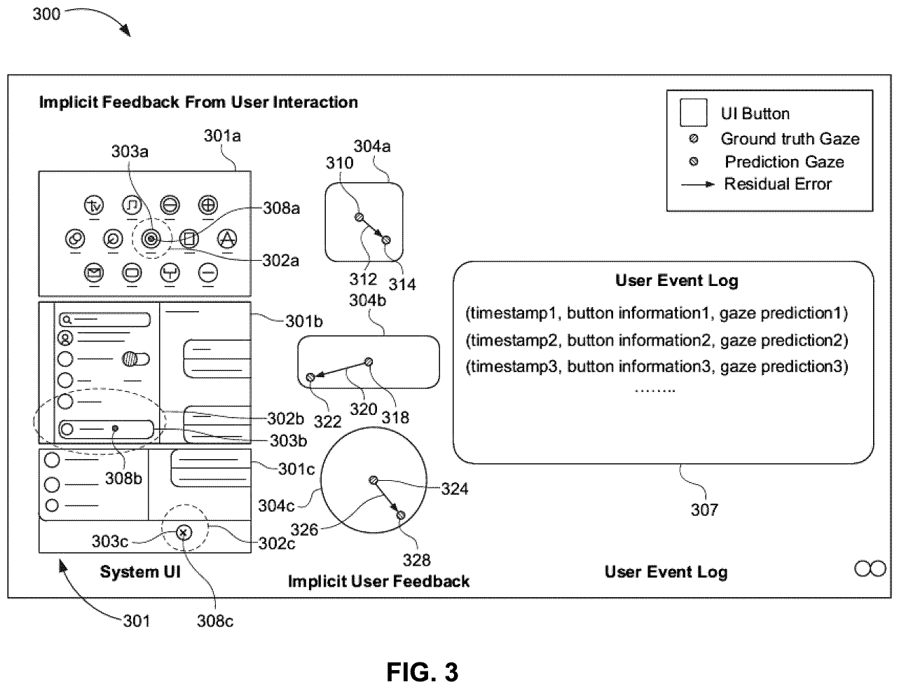

FIG. 3 illustrates a view representing implicit feedback obtained based on predicted user intention with respect to user actions associated with a user interface (UI), in accordance with some implementations.

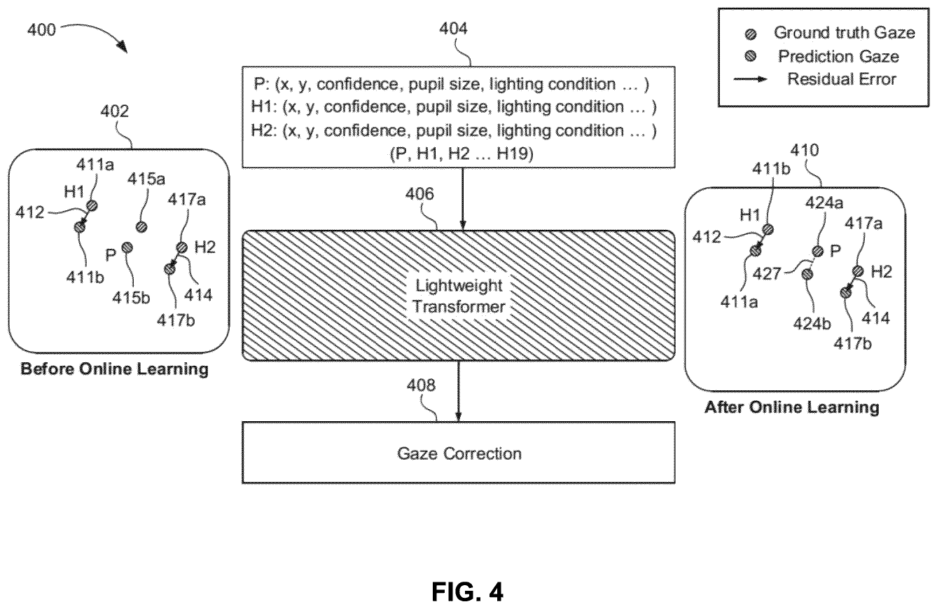

FIG. 4 illustrates a view representing the application of online gaze correction, in accordance with some implementations.

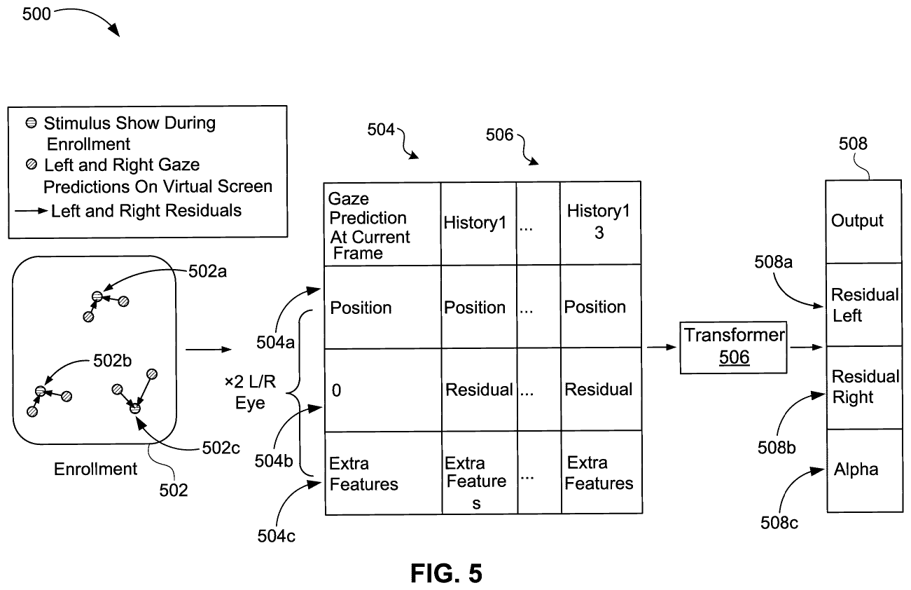

FIG. 5 illustrates view of a gaze prediction process utilizing a transformer configured to generate a corrected gaze position based on enrollment data and matrix, in accordance with some implementations.

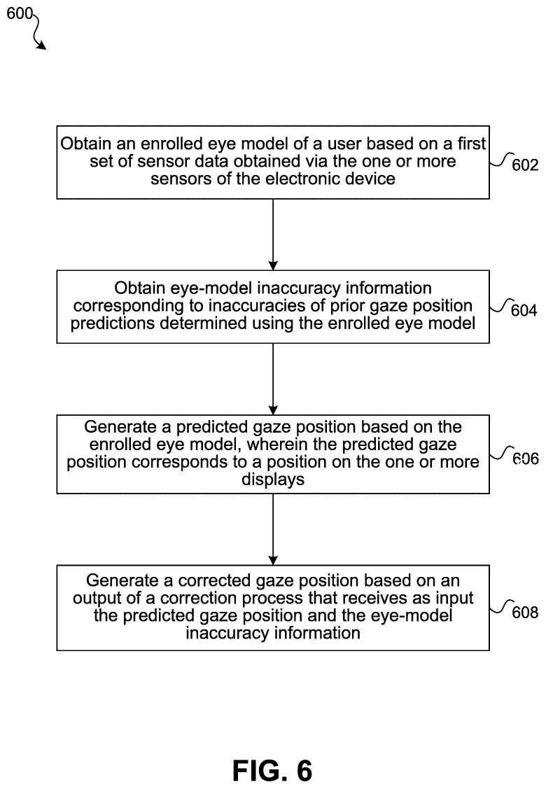

FIG. 6 is a flowchart representation of an exemplary method that predicts and corrects gaze position, in accordance with some implementations.

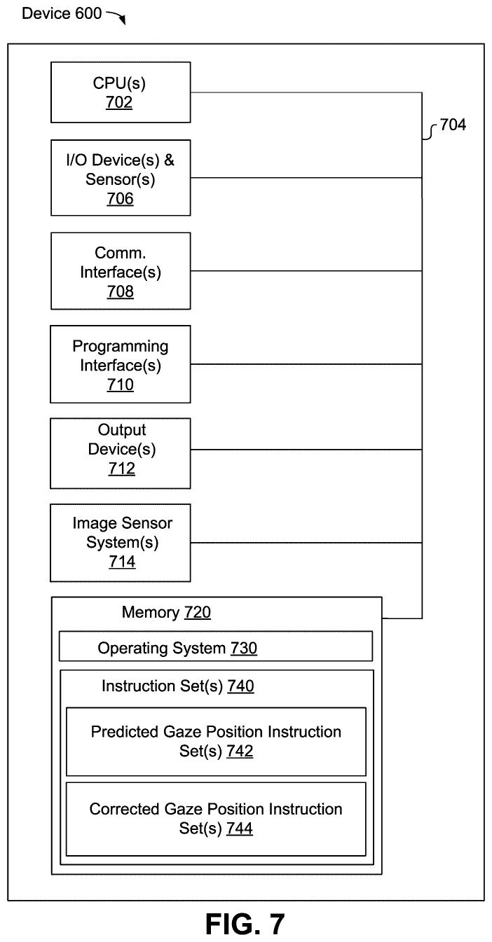

FIG. 7 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

FIGS. 1A-B illustrate exemplary electronic devices 105 and 110 operating in a physical environment 100. In the example of FIGS. 1A-B, the physical environment 100 is a room that includes a desk 120. The electronic devices 105 and 110 may include one or more cameras, microphones, depth sensors, or other sensors that can be used to capture information about and evaluate the physical environment 100 and the objects within it, as well as information about the user 102 of electronic devices 105 and 110. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

Various implementations disclosed herein include devices, systems, and methods that implement gaze tracking approaches that use image data. In some implementations, gaze may be tracked using imaging data to determine eye position or eye orientation using a pupil plus glint model, using a depth camera (e.g., stereo, structured light projection, time-of-flight (ToF), etc.) or an infrared (IR) camera with 3D point cloud registration, or using an appearance-based model.

In some implementations, a gaze position (e.g., gaze point on a virtual display) is predicted by adjusting a 3D model-based (e.g., an enrolled eye model) prediction via usage of errors and residuals determined using predictions associated with historical/prior user-specific gaze events and actual gaze direction/ground truth data that is assumed based on user behavior during the prior events. For example, a user gaze position may be assumed to be located at a center of a button (e.g., a virtual button or switch of an interface) when the user pinches to “click” (e.g., activate) on the button.

In some implementations, a 3D eye model-based prediction may use a 3D model of a user's eye that accounts for cornea shape, pupil radius, and/or additional eye dimensions determined during an enrollment process. In some implementations, errors and/or residuals may be determined based on applying the 3D model to a recording of an enrollment process and identifying differences at input events (e.g., pinches) between a gaze predicted based on the 3D model using the recording and a center of the UI element that the user interacted with by pinching.

In some implementations, historical user-specific gaze event data may be used to produce a set (e.g., matrix/14 tokens) of historical and/or current user data that may be used as input to a model/transformer that produces output from which a gaze correction is provided during use after enrollment (e.g., online).

FIG. 2 illustrates is a diagram depicting a 3D eye model 200 comprising a 3D representation of an eyeball to illustrate example eye modeling implementations for gaze tracking, in accordance with some implementations. 3D eye model 200 comprises a representation of a cornea 220 that includes a transparent front part of an eye that covers the iris 215, pupil 243, and anterior chamber 217 of the eye. As shown in FIG. 2, the 3D eye model 200 uses a spherical model of the cornea 220. Other 3D representations of the cornea 220 can alternatively be used. In some implementations, 3D eye model 200 may be generated independently or uniquely for each user or person. As shown in FIG. 2, the 3D eye model 200 illustrates a local X-axis 247, a local Z-axis (i.e., an optical center axis) 239, and a visual axis 241.

In some implementations, the local Z-axis 239 may be identified and used as an indication of a gaze direction of the eye. In some implementations, the visual axis 241 may be identified and used as an indication of the gaze direction of the eye. The visual axis 241 is the actual gaze direction, as perceived by a user, and has a kappa angle 237 (i.e., an angular offset) from the observable local Z-axis 239. The kappa angle 237 (e.g., 2 degrees vertically and 5 degrees horizontally) between visual axis 241 and the local Z-axis 239 may vary by each individual person. In some implementations, the visual axis 241 extends from the fovea (e.g., region of highest visual acuity on the retina) and passes through the nodal point of the cornea-crystalline lens optical system (e.g., approximated with the center of curvature of the cornea) and is generally non-observable. Thus, in some implementations, the kappa angle 237 between visual axis 241 and the local Z-axis 239 is usually calibrated with an enrollment procedure where a user is required to fixate a stimulus (e.g., dot) at known locations, and an offset between the measured optical axis and the actual location of the target is the visual axis 241 offset. For example, when a user fixates on a UI button or a stimulus during an enrollment procedure, they may fixate on the UI button for several frames. In response, a single frame (of the frames) may be used as a representative frame for the aforementioned fixation.

In some implementations, when image data (e.g., image sensor) includes images of the retina, the location of the fovea can be determined, and the visual-optical axis offset is measured directly.

In some implementations, estimating a gaze direction of the eye is based on determining two locations on the local Z-axis 239. Some implementations determine a 3D spatial position of an iris center 215a and a 3D spatial position of a cornea center 220a as the two locations on the local Z-axis 239. Some implementations determine a 3D spatial position of the eyeball rotation center 210 and a 3D spatial position of the cornea center 220a as the two locations on the local Z-axis 239. The two positions can be determined based on information from various sensors on a device, known relative spatial positions of those sensors (e.g., extrinsic parameters of an imaging), and generic or user-specific eye models.

In some implementations, a position of the cornea center 220a is determined based on identifying spatial attributes of the cornea 220. For example, the 3D spatial position of the cornea 220 (e.g., the depths/locations of one or more glints on the surface of the cornea) may be determined using a sensor (e.g., a sensor configured to detect glints generated from an illumination source on the device). The position of the cornea center 220a may then be determined based on the spatial position of the cornea 220 and a cornea model. In some implementations, images of a user's eyes captured by gaze tracking cameras may be analyzed to detect glints from light sources and the pupil 243. For example, the glint-light source matches are used to determine the cornea center 220a, a pupil center is determined, which together are used to determine the local Z-axis 239.

In some implementations, a position of the iris center 215a is determined based on identifying spatial attributes of the iris 215. For example, the 3D spatial position of the iris 215 (e.g., an iris plane, iris boundary, etc.) may be determined using one or more RGB or IR images of the eye and depth values from a depth map corresponding to the RGB or IR images. The iris center 215a may then be determined based on the spatial attributes of the iris 215 and a generic or user-specific model of the eye. In some implementations, the eyeball rotation center 210 of the eye may then be determined based on the spatial position of the iris 215.

In some implementations, a position of the eyeball rotation center 210 is determined based on identifying spatial attributes of the limbus 234 (e.g., limbus center). For example, the 3D spatial position of the limbus 234 may be determined using one or more RGB or IR images of the eye and depth values from a depth map corresponding to the RGB or IR images. In some implementations, given 2D images of the limbus 234 and a previously determined limbus model, the pose (e.g., a 3D position and 3D orientation) of the limbus 234 may then be determined. The rotation center of the eyeball 210 may then be determined based on the spatial position of the limbus 234.

In some implementations, a position of the eyeball rotation center 210 is determined based on identifying spatial attributes of the sclera 232 (e.g., sclera surface). For example, the 3D spatial position of the sclera 232 may be determined using one or more RGB or IR images of the eye, the surface of portions of the sclera 232 can be determined in the corresponding depth information, and the sclera surface is used to determine a 3D position of the rotation center 210 of the eye. In some implementations, additional portions (e.g., pupil 243) of the eye are used to determine the gaze direction or orientation of the local Z-axis 239.

In some implementations, a pupil model 255 is generated. Pupil model 255 may be a cove representing a position and orientation of pupil 243 as a function of a pupil radius.

In some implementations 3D eye model 200 may include information associated with a 3D geometry of the eye (e.g., cornea shape, pupil radius (e.g., illustrated via pupil model), other eye dimensions, etc.) that may be used to make a 3D eye-model-based prediction of gaze position based on a 3D position of a portion of the user's eye relative to eye tracking components and HMD display. 3D eye model 200 may generated based on a first set of sensor data obtained during an enrollment period. The first set of sensor data may be recorded and used to make predictions using the same sensor data for comparison with ground truth gaze positions (e.g., assumed gaze positions at input events) to generate historical eye-model inaccuracy information. The historical eye-model inaccuracy information may be based on current lighting conditions that differ from lighting conditions detected during enrollment. Likewise, the historical eye-model inaccuracy information may be based on a current cornea curvature change with respect to a cornea curvature of a user detected during enrollment (e.g., a cornea curvature may change due to aging).

FIG. 3 illustrates a view 300 representing implicit feedback 304a, 304b, and 304c obtained based on predicted user intention with respect to user actions associated with a user interface (UI) 301, in accordance with some implementations. UI 301 comprises a UI interface portion 301a, a UI interface portion 301b, and a UI interface portion 301c. In some implementations, prior use of an eye-model may be used to produce gaze predictions in comparison with ground truth gaze information such as assigning a button center region as a ground truth for a user gaze when a user performs a gesture with respect to a UI element. For example, a user may perform a pinch gesture (e.g., fingers coming together and touching) to select or “click” a virtual button and it may be predicted that the user is looking (gaze) at a center of the virtual button.

In some implementations, implicit feedback 304a (i.e., associated with user intention) is obtained based on predicted user intention with respect to actual/ground truth user actions performed with respect to virtual button 303a (e.g., a UI element) within a region 302a of UI interface portion 301a. For example, a user may perform a gesture (e.g., a pinch gesture) to select virtual button 303a and in response it may be predicted that user gaze is directed at a portion 308a of virtual button 303a. Accordingly, implicit feedback 304a represents a residual error 312 (e.g., inaccuracy information) between a predicted gaze location 314 and ground truth gaze location 310.

In some implementations, implicit feedback 304b (i.e., associated with user intention) is obtained based on predicted user intention with respect to actual/ground truth user actions performed with respect to virtual button 303b within a region 302b of UI interface portion 301b. For example, a user may perform a gesture (e.g., a pinch gesture) to select virtual button 303b and in response it may be predicted that user gaze is directed at a portion 308b of virtual button 303b. Accordingly, implicit feedback 304b represents a residual error 320 (e.g., inaccuracy information) between a predicted gaze location 322 and ground truth gaze location 318.

In some implementations, implicit feedback 304c (i.e., associated with user intention) is obtained based on predicted user intention with respect to actual/ground truth user actions performed with respect to virtual button 303c within a region 302c of UI interface portion 301c. For example, a user may perform a gesture (e.g., a pinch gesture) to select virtual button 303c and in response it may be predicted that user gaze is directed at a portion 308c of virtual button 303c. Accordingly, implicit feedback 304c represents a residual error 326 (e.g., inaccuracy information) between a predicted gaze location 328 and ground truth gaze location 324.

In some implementations, a user event log 307 is generated. User log 307 may include a timestamp, ground truth, and a gaze prediction associated with implicit feedback 304a, 304b, and 304c.

FIG. 4 illustrates a view 400 representing an online gaze correction process, in accordance with some implementations. View 400 illustrates a gaze prediction 402 occurring prior to online learning (e.g., a predicted gaze based on an eye model from enrollment during a user session) and a corrected gaze location 410 (e.g., a new predicted gaze location) occurring subsequent to online learning. In some implementations, a user event log 404 comprises information associated with gaze prediction 402 and gaze prediction 410. For example, user event log 404 may include input information associated with a current gaze prediction such as, inter alia, an x/y position on a display at which a gaze is directed, ground truth confidence values, pupil size (indicating lighting conditions) representing ground truth features and history point features, UI element size, a number of visible IR glints on each camera frame, iris ellipse parameters in 2D on each camera frame (major axis, minor axis, and orientation), pupil ellipse parameters in 2D on each camera frame (major axis, minor axis, and orientation), a fraction of the pupil ellipse that is visible (i.e., fraction of the pupil that is not occluded by eyelid), a 3D eye model cornea radius, a measure of the contrast between the pupil and the iris, 3D eye model enrollment residual errors (e.g. the min, max, mean, and median distance over all enrollment frames between the back projected pupil center and the predicted pupil center on the 2D image), larger values indicating that the enrollment was likely unsuccessful for the given eye, a 3D eye model's pose: pitch, yaw, and roll, an eye relief estimate of how far the device sits from the eye at each frame, etc. For example, in some implementations, a size of a UI element may be determined based on determining that it would be unlikely that a user will look at a center of a UI element if the UI element comprises a large size such as, for example, virtual button 303b of FIG. 3 as the user may be more likely to look at alternative features (e.g., text) of the UI element during selection. Therefore, instances associated with a user interacting with a small UI element (e.g., virtual button 303c in FIG. 3) may be used for the online gaze correction process as it may be more likely that the user is looking at a center of the UI element in this instance.

In some implementations, it may be desirable to utilize prediction and ground truth gaze information associated with user interactions with UI elements that are less than a threshold size as input into the online gaze correction process to enable a better chance that the user is looking at a center of a UI element that comprises a smaller size as described, supra.

In some implementations, a dominant eye may be detected during an enrollment process and therefore may be weighted more heavily than a non-dominant eye with respect the online gaze correction process.

In some implementations, if image data captured during device usage is detected as being blurry for one eye, a lower weighting may be assigned to the blurry eye. In some implementations, an online gaze calibration process may be configured to modify a dominant eye over time if a first eye (e.g., a left eye) is weighted more heavily than a second eye (e.g., a right eye) on a consistent basis.

In some implementations, an initial gaze location P is corrected (online/in real time) based on the online gaze correction process that utilizes H1 and H2 data (of gaze prediction 402) as input into a lightweight transformer 406. For example, light weight transformer 406 obtains as input, the ground truth gaze locations 411a and 417a, residual errors 412 and 414, and prediction gaze locations 411b and 417b of H1 and H2 data in combination with ground truth gaze location 415a and prediction gaze location 415b of the prediction gaze data P. In response light weight transformer 406 and outputs a corrected prediction gaze location 424a of prediction gaze data P subsequent to being shifted via connection 427 between corrected prediction gaze location 424a and prediction gaze location 424b such that corrected prediction gaze location 424a of prediction gaze data P overlays with a ground truth gaze location.

In some implementations, transformer 406 may be trained as a single network but during device implementation, transformer 406 may be split into two portions. For example, a first portion of transformer 406 may only run intermittently in the background and its output may be is cached to save computing power. Likewise, the first portion of transformer 406 may be a self-attention network that operates only on history tokens to compute some embedding. In some implementations, a second portion of transformer may obtain as input, the cached data in combination with current frame data and runs at 90 Hz thereby providing a tradeoff between accuracy and latency.

FIG. 5 illustrates view 500 of a gaze prediction process utilizing a transformer 506 configured to generate a corrected gaze position based on enrollment data 502 and a matrix 504 comprising historical gaze position data 506, in accordance with some implementations. Enrollment data 502 is associated with an enrollment process that identifies how a device interprets eye movements. In some implementations, enrollment data 502 comprises a predicted gaze position 502a, a predicted gaze position 502b, and a predicted gaze position 502c. Each of predicted gaze position 502a, predicted gaze position 502b, and predicted gaze position 502c represent left and right eye gaze predictions with respect to a stimulus (e.g., a UI element such as, inter alia, a virtual button or icon) presented to a user during enrollment and errors/residuals. In some implementations, for each stimulus shown during an enrollment session, associated sensor data is recorded and replayed to provide input to an eye model to generate gaze position predictions that may be compared to ground truth gaze positions with respect to left and right eye views.

In some implementations, sensor errors from device drops or other events may cause a device to inaccurately track gaze (subsequent to gaze tracking during enrollment) thereby creating residual errors being tracked as historical data such that once a threshold number of times or threshold residual error distance amount has been exceeded, an online calibration process is executed using the historical data.

In some implementations, historical gaze position data 506 may be represented by tokens (e.g., objects representing an association with performing an operation) in matrix 504 for input into transformer 506. For example, each enrollment point (e.g., 13 enrollment points) of enrollment data 502 may be associated with a token representing a known position of gaze predictions 504a, errors/residuals 504b, and additional features 504c such as, inter alia, a pupil size, a limbus size, 2D and 3D features associated with an eye, etc. Subsequently, matrix 504 is input into transformer 506 (e.g., a model) to generate an output 508 associated with a gaze prediction. Output 506 comprises a residual left output 508a (e.g., x/y coordinates for a predicted residual/predicted error for a left eye), a residual right output 508b (e.g., x/y coordinates for a right eye correction), and an alpha 508c comprising a number between 0 and 1 to provide an average between a left eye and a right eye to obtain a singular binocular prediction based on a user only viewing a single point.

FIG. 6 is a flowchart representation of an exemplary method 600 that predicts a gaze position and corrects that gaze position prediction using a process accounting for historical inaccuracy of the 3D eye model-based predictions, in accordance with some implementations. In some implementations, the method 600 is performed by a device, such as a mobile device, desktop, laptop, HMD, or server device. In some implementations, the device has a screen for displaying images and/or a screen for viewing stereoscopic images such as a head-mounted display (HMD such as e.g., device 105 or 110 of FIG. 1). In some implementations, the method 600 is performed by processing logic, including hardware, firmware, software, or a combination thereof. In some implementations, the method 600 is performed by a processor executing code stored in a non-transitory computer-readable medium (e.g., a memory). Each of the blocks in the method 600 may be enabled and executed in any order.

At block 602, the method 600 obtains an enrolled eye model of a user determined based on sensor data obtained via one or more sensors of an electronic device. In some implementations, the enrolled eye model of the eye comprises information associated with a 3D geometry of the eye of the user for generating the prior gaze position predictions based on a 3D position of a portion of the eye of the user with respect to eye tracking components and one or more displays of the electronic device. A 3D geometry of the eye of the user may include, inter alia, a cornea shape, a pupil radius, additional eye dimensions, etc. as described with respect to FIG. 2.

At block 604, the method 600 obtains eye-model inaccuracy information corresponding to inaccuracies of prior gaze position predictions that were determined based on the enrolled eye model. For example, inaccuracy information may include a residual error 312 between a gaze prediction 310 and ground truth gaze information 314 as described with respect to FIG. 3. In some implementations, the 3D model of the eye is based on the first set of sensor data obtained and recorded during an enrollment process for playback to generate predictions comparison with ground truth gaze positions for generating the eye-model inaccuracy information. For example, ground truth gaze positions may include assumed gaze positions at input events such as ground truth gaze information 328 as described with respect to FIG. 3.

In some implementations, the inaccuracies comprise errors in the prior gaze position predictions with respect to ground truth gaze positions. In some implementations, the ground truth gaze positions comprise assumed gaze positions at input events such as virtual button (e.g., virtual button 303 in FIG. 3) activation. In some implementations, the ground truth gaze positions may include manually identified intended gaze positions. For example, a UI element designer may identify intended gaze positions.

In some implementations, the eye-model inaccuracy information may include a set (e.g., matrix/tokens such as matrix 504 in FIG. 5) of historical user gaze event data being input into the correction process in combination with current environment condition data (e.g., light condition data, etc.) to generate the corrected gaze position in real time during a current user session.

In some implementations, the eye-model inaccuracy information may include a set (e.g., matrix/tokens) of current user gaze event data being input into the correction process in combination with current environment condition data (e.g., light condition data, etc.) to generate the corrected gaze position in real time during a current user session.

In some implementations, current environment condition data may include light condition data.

At block 606, the method 600 generates a predicted gaze position (e.g., predicted gaze position 502b of FIG. 5) based on the enrolled eye model. In some implementations, the predicted gaze position corresponds to a position on one or more displays of the electronic device.

In some implementations, a size of a UI element (e.g., a UI element such as virtual button 303a of FIG. 3) may be determined. For example, a size of a UI element may be determined based on an assumption that it may be unlikely that a user will look at a center of a UI element if the UI element comprises a large size such as, for example, virtual button 303b of FIG. 3 as the user may be more likely for the user to look at text within the UI element during selection. Therefore, instances associated with a user interacting with a small UI element (e.g., virtual button 303c in FIG. 3) may be used for a subsequent gaze correction process (of block 608 as described, infra) as it may be more likely that the user is looking at a center of the UI element in this instance. For example, a process for determining a button that the user is attempting to interact with may include using an additional set of algorithms to classify a current frame as belonging to either a stabilizing event, a saccade, or a blink event to provide associated information. Therefore, a high-level understanding of operation of the additional set of algorithms may be required. For example, only pinch interactions may be recorded when the user is in a stabilizing event but the user may additionally move their head and use their eyes to compensate for the head motion but the pinch interactions may still be determined to be a stabilizing event.

In some implementations, it may be desirable utilize prediction and ground truth gaze information associated with user interactions with UI elements having a size that is less than a threshold size as input into the subsequent gaze correction process. Utilizing a UI element having a smaller size (e.g., smaller than a threshold size) may enable a better chance that the user is looking at a center of a UI element that comprises a smaller size as described, supra.

In some implementations, a dominant eye detected during enrollment may be weighted more heavily than a non-dominant eye with respect to input into the subsequent gaze correction process as described with respect to FIG. 4. Likewise, if image data captured during device use is detected as being blurry for one eye, less weight may be given to the blurry eye. Furthermore, an online gaze calibration process may be configured to change a dominant eye over time if one eye is weighted more heavily than the other on a consistent basis.

At block 608, the method 600 generates a corrected gaze position based on an output of a correction process that receives as input the predicted gaze position and the eye-model inaccuracy information as described with respect to FIG. 4. In some implementations, the correction process comprises a transformer or model (e.g., transformer 506 in FIG. 5) implemented process.

FIG. 7 is a block diagram of an example device 700. Device 700 illustrates an exemplary device configuration for electronic devices 105 and 110 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 700 includes one or more processing units 702 (e.g., microprocessors, ASICs, FPGAs, GPUs, CPUs, processing cores, and/or the like), one or more input/output (I/O) devices and sensors 706, one or more communication interfaces 708 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 710, output devices (e.g., one or more displays) 712, one or more interior and/or exterior facing image sensor systems 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more IR cameras (e.g., inward facing cameras and outward facing cameras of an HMD), one or more infrared sensors, one or more heat map sensors, and/or the like.

In some implementations, the one or more displays 712 are configured to present a view of a physical environment, a graphical environment, an extended reality environment, etc. to the user. In some implementations, the one or more displays 712 are configured to present content (determined based on a determined user/object location of the user within the physical environment) to the user. In some implementations, the one or more displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 712 correspond to diffractive, reflective, polarized, holographic, etc. waveguide displays. In one example, the device 700 includes a single display. In another example, the device 700 includes a display for each eye of the user.

In some implementations, the one or more image sensor systems 714 are configured to obtain image data that corresponds to at least a portion of the physical environment 100. For example, the one or more image sensor systems 714 include one or more RGB or IR cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 714 further include illumination sources that emit light, such as a flash. In various implementations, the one or more image sensor systems 714 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB or IR camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 700 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 700 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 700.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 includes a non-transitory computer readable storage medium.

In some implementations, the memory 720 or the non-transitory computer readable storage medium of the memory 720 stores an optional operating system 730 and one or more instruction set(s) 740. The operating system 730 includes procedures for handling various basic system services and for performing hardware dependent tasks. In some implementations, the instruction set(s) 740 include executable software defined by binary information stored in the form of electrical charge. In some implementations, the instruction set(s) 740 are software that is executable by the one or more processing units 702 to carry out one or more of the techniques described herein.

The instruction set(s) 740 includes a predicted gaze position instruction set 742 and a corrected gaze position instruction set 744. The instruction set(s) 740 may be embodied as a single software executable or multiple software executables.

The predicted gaze position instruction set 742 is configured with instructions executable by a processor to generate a predicted gaze position based on a 3D model of a user eye.

The corrected gaze position instruction set 744 is configured with instructions executable by a processor to generate a corrected gaze position based on an output of a correction process (e.g., model/transformer) that inputs the predicted gaze position and eye-model inaccuracy information.

Although the instruction set(s) 740 are shown as residing on a single device, it should be understood that in other implementations, any combination of the elements may be located in separate computing devices. Moreover, FIG. 7 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at an electronic device having a processor, one or more sensors and one or more displays:
obtaining an enrolled eye model of a user that was determined based on sensor data obtained via the one or more sensors of the electronic device;
obtaining eye-model inaccuracy information corresponding to inaccuracies of prior gaze position predictions determined using the enrolled eye model;
generating a predicted gaze position based on the enrolled eye model, wherein the predicted gaze position corresponds to a position on the one or more displays; and
generating a corrected gaze position based on an output of a correction process that receives as input the predicted gaze position and the eye-model inaccuracy information.

2. The method of claim 1, wherein the enrolled eye model comprises information associated with a 3D geometry of an eye of the user used to generate the prior gaze position predictions based on a 3D position of a portion of the eye of the user with respect to eye tracking components and the one or more displays.

3. The method of claim 2, wherein the enrolled eye model is based on the sensor data obtained and recorded during an enrollment process for playback to generate predictions comparison with ground truth gaze positions for generating the eye-model inaccuracy information.

4. The method of claim 1, wherein the inaccuracies comprise errors in the prior gaze position predictions with respect to ground truth gaze positions.

5. The method of claim 4, wherein the ground truth gaze positions comprise assumed gaze positions at input events.

6. The method of claim 4, wherein the ground truth gaze positions comprise manually identified intended gaze positions.

7. The method of claim 1, wherein the correction process comprises a transformer implemented process.

8. The method of claim 1, wherein the eye-model inaccuracy information comprises a set of historical user gaze event data being input into the correction process in combination with current environment condition data to generate the corrected gaze position in real time during a current user session.

9. The method of claim 1, wherein the eye-model inaccuracy information comprises a set of current user gaze event data being input into the correction process in combination with current environment condition data to generate the corrected gaze position in real time during a current user session.

10. The method of claim 9, wherein the current environment condition data comprises light condition data.

11. The method of claim 1, wherein the inaccuracy information comprises a spatial difference between the predicted gaze location and a ground truth gaze location with respect to a UI element.

12. The method of claim 11, wherein the UI element comprises a geometrical size that is less than a threshold size.

13. The method of claim 1, further comprising:
detecting, during an enrollment process, dominant eye of the user; and
assigning a weighting factor to data associated with the dominant eye with respect to the other eye of the user, wherein the correction process further receives as input, the weighting factor applied to the data associated with the dominant eye with respect to the other eye of the user.

14. The method of claim 1, wherein the sensor data comprises image data detected to be blurry with respect to a first eye of the user eye, and wherein the method further comprises:
assigning a weighting factor to the first eye that is less than to a weighting factor applied to a second eye of the user.

15. The method of claim 1, wherein an online gaze calibration process may be configured to modify the corrected gaze position of a dominant eye of the user over time if a weighting factor applied to the dominant eye is greater than a weighting factor applied a second eye of the user on a consistent basis.

16. A non-transitory computer-readable medium comprising instructions that when executed by a processor cause the processor to perform operations comprising:
obtaining an enrolled eye model of a user that was determined based on sensor data obtained via the one or more sensors of the electronic device;
obtaining eye-model inaccuracy information corresponding to inaccuracies of prior gaze position predictions determined using the enrolled eye model;
generating a predicted gaze position based on the enrolled eye model, wherein the predicted gaze position corresponds to a position on the one or more displays; and
generating a corrected gaze position based on an output of a correction process that receives as an input the predicted gaze position and the eye-model inaccuracy information.

17. An electronic device comprising:
one or more sensors;
one or more displays;
a non-transitory computer-readable storage medium; and
one or more processors coupled to the non-transitory computer-readable storage medium, wherein the non-transitory computer-readable storage medium comprises program instructions that, when executed on the one or more processors, cause the electronic device to perform operations comprising:
obtaining an enrolled eye model of a user that was determined based on sensor data obtained via the one or more sensors of the electronic device;
obtaining eye-model inaccuracy information corresponding to inaccuracies of prior gaze position predictions determined using the enrolled eye model;
generating a predicted gaze position based on the enrolled eye model, wherein the predicted gaze position corresponds to a position on the one or more displays; and
generating a corrected gaze position based on an output of a correction process that receives as an input the predicted gaze position and the eye-model inaccuracy information.

18. The electronic device of claim 17, wherein the enrolled eye model comprises information associated with a 3D geometry of the eye of the user (cornea shape, pupil radius, other eye dimensions) used to generate the prior gaze position predictions based on a 3D position of a portion of the eye of the user with respect to eye tracking components and the one or more displays.

19. The electronic device of claim 17, wherein the enrolled eye model is based on the first set of sensor data obtained and recorded during an enrollment process for playback to generate predictions comparison with ground truth gaze positions (e.g., assumed gaze positions at input events) for generating the eye-model inaccuracy information.

20. The electronic device of claim 17, wherein the inaccuracies comprise errors in the prior gaze position predictions with respect to ground truth gaze positions.
